(19) United States
(12) Patent Application Publication
(10) Pub. No.: US 2016/0033945 A1
(43) Pub. Date: Feb. 4, 2016

(54) HOUSEHOLD APPLIANCE AND CONTROL METHOD THEREFOR, AND HOUSEHOLD APPLIANCE SYSTEM

(71) Applicant: BOE TECHNOLOGY GROUP CO., LTD., Beijing (CN)

(72) Inventor: Kailiang Zhang, Beijing (CN)

(21) Appl. No.: 14/418,775

(22) PCT Filed: May 23, 2014
(86) PCT No.: PCT/CN2014/078289

§ 371 Date: Jan. 30, 2015

(30) Foreign Application Priority Data
Dec. 31, 2013 (CN) 201310750352.4

(51) Int. Cl. G05B 15/02; H04W 4/00

(52) U.S. Cl. CPC G05B 15/02; H04W 4/008

(57) ABSTRACT

Embodiments of the present invention disclose a household appliance and a control method therefor, and a household appliance system, which pertain to the field of electrical technology. Each household appliance can be used by a user more conveniently. A master household appliance provided by the present invention comprises: a main Bluetooth module configured to receive and send information; and a main control module configured to communicate with at least one slave household appliance via the main Bluetooth module so as to control a working state of the slave household appliance. A slave household appliance provided by the present invention comprises: a sub Bluetooth module configured to receive and send information; and a sub control module configured to communicate with a master household appliance via the sub Bluetooth module so as to receive a control instruction from the master household appliance and control a working state of the slave household appliance based on the received control instruction. A household appliance system provided by the present invention comprises at least one master household appliance and at least one slave household appliance. The master household appliance may be applied to a TV set.

### BACKGROUND OF THE INVENTION

1. Field of the Invention

The present invention relates to technical field of electrical appliances, and specifically to a household appliance and a control method therefor, and a household appliance system.

2. Description of the Related Art

With development of technology, more and more kinds of household appliances appear and facilitate daily life of people.

During making the invention, the present inventor notices that the following issue exists in current household appliances. Household appliances, according to the functions thereof, should be disposed at different locations of a house, such as a living room, a bedroom, a kitchen, a bathroom and the like. Typically, a TV set, a Home Theater System, and an air conditioner are provided with remote controllers, so that the control thereof are facilitated. However, other household appliances such as a refrigerator, a washing machine, an electric cooker, an electromagnetic oven, an electric pressure cooker and the like are not provided with remoter controllers. When using such household appliances, a user should walk to the location of each household appliance and control the household appliance through a control panel on the household appliance, thus usages of such household appliances are not convenient.

### SUMMARY OF THE INVENTION

The present invention has been made to alleviate at least one aspect of the above mentioned disadvantages.

The present invention provides a household appliance and a control method therefor, and a household appliance system, so that each household appliance can be used more conveniently.

According to one aspect of the present invention, there is provided a master household appliance, comprising a main Bluetooth module configured to receive and send information and a main control module configured to communicate with at least one slave household appliance via the main Bluetooth module so as to control a working state of the slave household appliance.

According to an exemplary embodiment of the present invention, the main Bluetooth module is configured to receive a control instruction sent by the main control module and send the control instruction to the slave household appliance.

According to another exemplary embodiment of the present invention, the master household appliance further comprises a main display module connected to the main control module for displaying working state information of the master household appliance and/or the slave household appliances.

According to another exemplary embodiment of the present invention, the main Bluetooth module is configured to receive the working state information sent by the slave household appliance and sends the working state information to the main control module, and the main display module is configured to display the working state information received by the main control module.

According to another exemplary embodiment of the present invention, the master household appliance further comprises a main input module connected to the main control module for inputting an operating instruction to the main control module.

According to another exemplary embodiment of the present invention, the master household appliance comprises a TV set or a computer.

According to another aspect of the present invention, there is provided a slave household appliance comprising a sub Bluetooth module configured to receive and send information and a sub control module configured to communicate with a master household appliance via the sub Bluetooth module so as to receive a control instruction from the master household appliance and control a working state of the slave household appliance based on the received control instruction.

According to an exemplary embodiment of the present invention, the sub control module sends current working state information of the slave household appliance to the sub Bluetooth module, and the sub Bluetooth module is configured to send received working state information to the master household appliance.

According to another exemplary embodiment of the present invention, the slave household appliance comprises an air conditioner, a refrigerator, a washing machine, an electric cooker, an electromagnetic oven, or an electric pressure cooker.

According to another aspect of the present invention, there is provided a household appliance system comprising at least one master household appliance as described above and at least one slave household appliance as described above.

According to another exemplary embodiment of the present invention, the household appliance system comprises one master household appliance and a plurality of slave household appliances controlled by the master household appliance.

According to another aspect of the present invention, there is provided a control method for a master household appliance comprising a main Bluetooth module and a main control module, the control method comprising steps of:

sending a control instruction to the main Bluetooth module through the main control module; and

receiving the control instruction from the main control module through the main Bluetooth module and sending the received control instruction to at least one slave household appliance.

According to another exemplary embodiment of the present invention, the master household appliance further comprises a main display module connected to the main control module for displaying working state information of the master household appliance and/or the slave household appliance.

According to another exemplary embodiment of the present invention, the master household appliance further comprises a main input module connected to the main control module for inputting an operating instruction to the main control module.

According to another aspect of the present invention, there is provided a control method for a slave household appliance comprising a sub Bluetooth module and a sub control module, the control method comprising steps of:

receiving a control instruction from a master household appliance through the sub Bluetooth module and sending the received control instruction to the sub control module; and

controlling a working state of the slave household appliance based on the received control instruction through the sub control module.

According to another aspect of the present invention, there is provided a control method for a household appliance system comprising a master household appliance and a slave household appliance, the control method comprising steps of:

sending a control instruction to the slave household appliance through the master household appliance;

receiving the control instruction sent by the master household appliance through the slave household appliance; and

controlling a working state of the slave household appliance based on the received control instruction.

As compared with prior arts, the technical solutions provided by the present invention have the following advantages: in the household appliance and a control method for the household appliance, and a household appliance system provided by the present invention, a master household appliance can send control instruction to a slave household appliance through a main Bluetooth module so as to control the slave household appliance. With the present invention, a user can control the slave household appliance only by operating the master household appliance, such that each household appliance can be used more conveniently.

### BRIEF DESCRIPTION OF THE DRAWINGS

The accompanying drawings used in the description of embodiments of the present invention will be briefly outlined in order to illustrate technical solutions according to the embodiments of the present invention more clearly.

FIG. 1 is a schematic diagram showing a master household appliance according to a first embodiment of the present invention;

FIG. 2 is a schematic diagram showing a slave household appliance according to a second embodiment of the present invention; and

FIG. 3 is a schematic diagram showing a household appliance system according to a third embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The description of the embodiments of the present invention in connection with the drawings should not be construed as a limitation to the invention; rather, it should be regarded as an interpretation to a general concept of the invention.

Technical solutions according to exemplary embodiments of the present disclosure will be described hereinafter clearly and fully with reference to the attached drawings.

### Embodiment 1

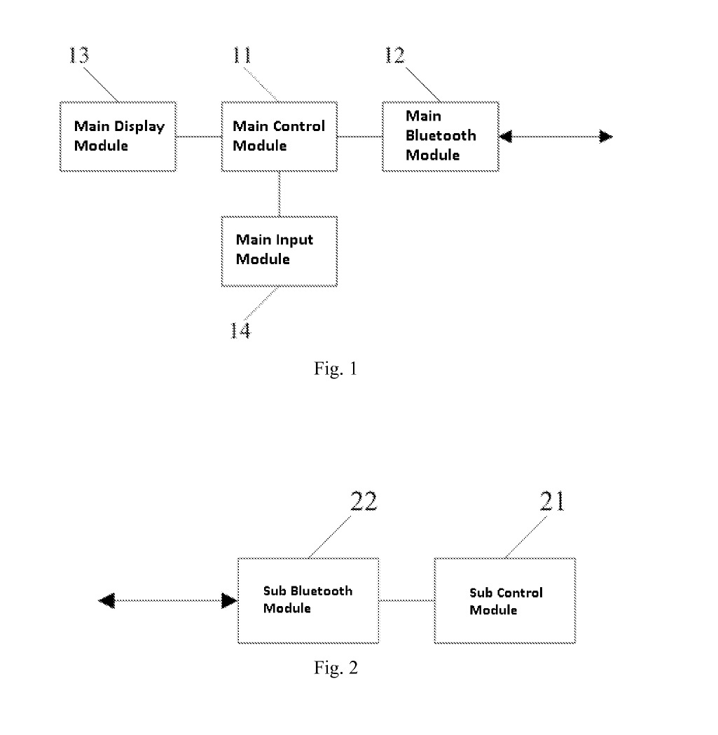

As shown in FIG. 1, the embodiment of the present invention provides a master household appliance, which comprises a main control module 11 and a main Bluetooth module 12 connected to the main control module 11. The main control module 11 sends control instructions to slave household appliances via the main Bluetooth module 12 so as to control the slave household appliances.

A control method for controlling the master household appliance comprises steps of:

S11: sending control instructions through the main control module 11; and

S12: transmitting the control instructions to the slave household appliances via the main Bluetooth module 12.

Specifically, the master household appliance may be a TV set or a computer, and in the present embodiment, a TV set is taken as an example. Mainboards of the TV set and the slave household appliances may be provided with a respective Bluetooth module or a Bluetooth module interface connected to a respective external Bluetooth module. An available communication distance of Bluetooth technology may be up to 30 meters, so that, generally, a range of a family house can be covered by Bluetooth signals.

A communication manner between the TV set and the slave household appliances is described as follows:

Firstly, a main Bluetooth module in the TV set is set to a master mode. Sub Bluetooth modules in the slave household appliances is set to a slave mode and in a findable state and may be selected to a silent working state, so that the slave household appliances can only communicate with the main Bluetooth module in the TV set.

The name, PIN code, address and the like of a sub Bluetooth module of each slave household appliance are pre-stored in the main Bluetooth module of the TV set, so that the TV set may be linked with each slave household appliance and implement data communication via the main Bluetooth module and the sub Bluetooth module.

The TV set according to the embodiment of the present invention can sent control instructions to the slave household appliances via the main Bluetooth module so as to control the slave household appliances. The slave household appliances can be controlled by a user just through operating the TV set, so that each household appliance can be used conveniently.

Furthermore, as shown in FIG. 1, the TV set according to the embodiment of the present invention further comprises a main display module 13 connected to the main control module 11, and specifically, the main display module 13 may be the display screen of the TV set. The main control module 11 is also used to receive working state information of the slave household appliances via the main Bluetooth module 12, and the main display module 13 is used to display the working state information received by the main control module 11.

When the working state information sent by the slave household appliances is received by the main control module 11, a user may watch the working state information through the screen of the TV set, so that the user may take notice of working state of each household appliance at any time.

Furthermore, the TV set according to the embodiment of the present invention further comprises a main input module 14 connected to the main control module 11, and the main input module 14 is used to input operating instructions to the main control module 11. Preferably, the main input module 14 may be provided in a remote controller of the TV set, so that a user may use the remote controller to input operating instructions to the main control module 11, then the main control module 11 sends control instructions to the slave household appliances via the main Bluetooth module 12, so as to facilitate the control of the slave household appliances by the user.

### Embodiment 2

As shown in FIG. 2, the embodiment of the present invention provides a slave household appliance, which comprises a sub control module 21 and a sub Bluetooth module 22 connected to the sub control module 21. The sub control module 21 receives control instructions sent by a master household appliance via the sub Bluetooth module 22 so that the slave household appliance can obtain the control instructions sent by the master household appliance, such that a user may operate the slave household appliance through the master household appliance.

Specifically, the slave household appliance may be an air conditioner, a refrigerator, a washing machine, an electric cooker, an electromagnetic oven, an electric pressure cooker or the like. The present embodiment will be described in detail by taking the refrigerator as an example.

A control method for controlling the slave household appliance comprises a step of:

S21: using the sub control module to receive control instructions sent by a master household appliance through the sub Bluetooth module.

Specifically, a communication manner between the refrigerator and the master household appliance is described as follows.

Firstly, a main Bluetooth module in the master household appliance is set to a master mode. A sub Bluetooth module in the refrigerator is set to a slave mode and in a findable state and may be selected to a silent working state, so as to ensure that the refrigerator can only communicate with the main Bluetooth module in the master household appliance.

The name, PIN code, address and the like of the sub Bluetooth module of the refrigerator are pre-stored in the main Bluetooth module of the master household appliance, so that the master household appliance may be linked with the refrigerator and implement data communication via the main Bluetooth module and the sub Bluetooth module.

The refrigerator according to the embodiment of the present invention can receive control instruction sent by the master household appliance via the sub Bluetooth module, so that the refrigerator is under control of the master household appliance. A temperature of each storage chamber of the refrigerator can be controlled by a user just through operating the master household appliance, so that the refrigerator can be used conveniently.

Furthermore, the sub control module 21 is also used to send working state information of the refrigerator to the master household appliance via the sub Bluetooth module 22 so that information of the refrigerator can be fed back, thereby the refrigerator can be suitably controlled by the master household appliance. For example, the sub control module 21 may send information about temperature of each storage chamber of the refrigerator to the master household appliance via the sub Bluetooth module 22, so that a user may, based on the information about the temperature of each storage chamber of the refrigerator, send control instructions via the Bluetooth module in the master household appliance to adjust the temperature of a certain storage chamber of the refrigerator.

### Embodiment 3

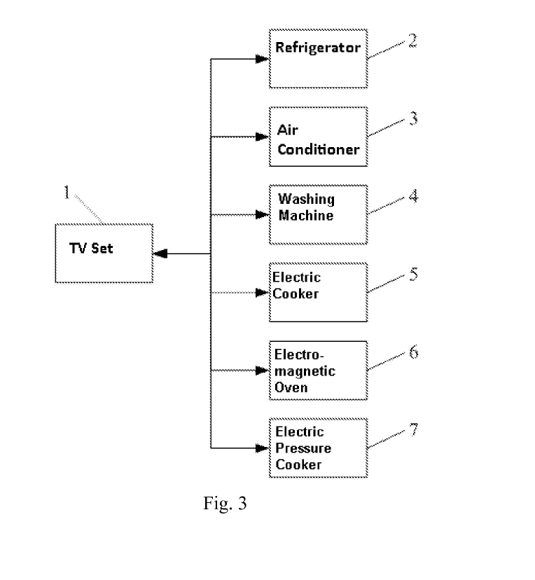

As shown in FIG. 3, the present invention further provides a household appliance system comprising at least one master household appliance and at least one slave household appliance, wherein the master household appliance in the present embodiment is the master household appliance provided in Embodiment 1, and preferably, the TV set 1. In other embodiments, the master household appliance may be a computer, or a combination of a TV set and a computer. In the present embodiment, the slave household appliance is the slave household appliance provided in Embodiment 2, which may comprises one or more household appliances selected from a refrigerator 2, an air conditioner 3, a washing machine 4, an electric cooker 5, an electromagnetic oven 6, an electric pressure cooker 7 and the like.

In the present embodiment, a communication manner between the master household appliance (e.g., a TV set) and the slave household appliances is described as follows.

Firstly, the main Bluetooth module in the TV set is set to a master mode. The sub Bluetooth module in a slave household appliance is set to a slave mode and in a findable state and may be selected to a silent working state, so that the slave household appliance can only communicate with the main Bluetooth module in the TV set.

The name, PIN code, address and the like of the sub Bluetooth module of each slave household appliance are pre-stored in the main Bluetooth module of the TV set, so that the TV set may be linked with each slave household appliance and implement data communication via the main Bluetooth module and the sub Bluetooth module.

An example of using the TV set to control the air conditioner is described as follows: after the main control module of the TV set receives working state information of the air conditioner with respect to temperature, working mode, timing information and the like, the working state information of the air conditioner may be selected by a user through a remoter controller of the TV set to be displayed on the screen of the TV set, and the user may set working state of the air conditioner based on the working state information. For example, if the temperature is needed to be adjusted, the working state of the air conditioner displayed on the screen of the TV set may be set via the remote controller of the TV set, then operating instructions are input to the main control module through using the remote controller, and control instructions are sent to the air conditioner through the main Bluetooth module in the TV set, and after the control instructions are received by the sub Bluetooth module of the air conditioner, an adjustment to the operating temperature of the air conditioner will be implemented.

An example of using the TV set to control the refrigerator is described as follows: after the main control module of the TV set receives working state information of the refrigerator with respect to temperature of each storage chamber, the working state information of the refrigerator may be selected by a user through a remoter controller of the TV set to be displayed on the screen of the TV set, and the user may set working state of the refrigerator based on the working state information. For example, if the temperature of a certain storage chamber is needed to be adjusted, the working state of the refrigerator displayed on the screen of the TV set may be set via the remote controller of the TV set, then operating instructions are input to the main control module through using the remote controller, and control instructions are sent to the refrigerator through the main Bluetooth module in the TV set, and after the control instructions are received by the sub Bluetooth module of the refrigerator, an adjustment to the temperature of corresponding storage chamber will be implemented.

An example of using the TV set to control the washing machine is described as follows: after the main control module of the TV set receives working state information of the washing machine with respect to working mode, water level, washing time and the like, the working state information of the washing machine may be selected by a user through a remoter controller of the TV set to be displayed on the screen of the TV set, and the user may set working state of the washing machine based on the working state information. For example, if the washing time is needed to be adjusted, the working state of the washing machine displayed on the screen of the TV set may be set via the remote controller of the TV set, then operating instructions are input to the main control module through using the remote controller, and control instructions are sent to the air conditioner through the main Bluetooth module in the TV set, and after the control instructions are received by the sub Bluetooth module of the washing machine, an adjustment to the washing time of the washing machine will be implemented.

An example of using the TV set to control the electric cooker is described as follows: after the main control module of the TV set receives working state information of the electric cooker with respect to working mode, working time and the like, the working state information of the electric cooker may be selected by a user through a remoter controller of the TV set to be displayed on the screen of the TV set, then the user may know whether the electric cooker is in a rice-cooking state or in a gruel-cooking state, and the user may know how long the electric cooker has been operating and when the cooking operation will be accomplished. Besides, the user may put rice into the electric cooker in advance and start cooking operation of the electric cooker at a certain time before a dinner and the cooking operation will be accomplished right at the dinner time.

An example of using the TV set to control the electromagnetic oven is described as follows: after the main control module of the TV set receives working state information of the electromagnetic oven with respect to working mode, heating power and the like, the working state information of the electromagnetic oven may be selected by a user may through a remoter controller of the TV set to be displayed on the screen of the TV set. For example, if the electromagnetic oven is being used to heating water, after the water is boiled, the user may input operating instructions to the main control module of the TV set through using the remote controller and send control instructions to the electromagnetic oven through the main Bluetooth module in the TV set, and after the control instructions are received by the sub Bluetooth module of the electromagnetic oven, the electromagnetic oven will be turned off, such that the water can be avoided from being boiled away and the user does not need to go to the kitchen to turn off the electromagnetic oven.

An example of using the TV set to control the electric pressure cooker is described as follows: after the main control module of the TV set receives working state information of the electric pressure cooker with respect to working time, internal pressure and the like, the working state information of the electric pressure cooker may be selected by a user through a remoter controller of the TV set to be displayed on the screen of the TV set, then the user may know the working time and internal pressure of the electric pressure cooker. If cooking of food is accomplished, the user may input operating instructions to the main control module of the TV set through using the remote controller and send control instructions to the electric pressure cooker through the main Bluetooth module in the TV set, and after the control instructions are received by the sub Bluetooth module of the electric pressure cooker, the electric pressure cooker will be turned off, such that an accident caused by internal over pressure of the electric pressure cooker can be avoided and the user does not need to go to the kitchen to turn off the electric pressure cooker.

In the household appliance system according to the embodiment of the present invention, a TV set can send control instructions to slave household appliances such as an air conditioner, a refrigerator, a washing machine, an electric cooker, an electromagnetic oven, an electric pressure cooker and the like so as to control the slave household appliances. When using the household appliance system, a user only needs to use a remote controller to operate the TV set so as to realize control of the slave household appliances, and thereby each household appliance can be used more conveniently.

In other embodiments, a computer may be used as a master household appliance, and the user may operate on the computer by using a mouse and a keyboard so as to realize control of the slave household appliances.

All that described above are just specific embodiments of the present invention, the scope of the present invention is not limited thereto. All the changes and equivalents that fall within the range of technical solutions disclosed by the present invention and are obvious to those skilled in the art should be included in the scope of the present invention. Therefore, the scope of the present invention is defined by the scope of the claims.

1. A master household appliance, comprising:
a main Bluetooth module configured to receive and send information; and
a main control module configured to communicate with at least one slave household appliance via the main Bluetooth module so as to control a working state of the at least one slave household appliance.

2. The master household appliance according to claim 1, wherein the main Bluetooth module is configured to receive a control instruction sent by the main control module and send the control instruction to the slave household appliance.

3. The master household appliance according to claim 1, further comprising:
a main display module connected to the main control module for displaying working state information of the master household appliance and/or the slave household appliance.

4. The master household appliance according to claim 3, wherein
the main Bluetooth module is configured to receive the working state information sent by the slave household appliance and send the working state information to the main control module, and the main display module is configured to display the working state information received by the main control module.

5. The master household appliance according to claim 1, further comprising:
a main input module connected to the main control module and configured to input an operating instruction to the main control module.

6. The master household appliance according to claim 1, wherein the master household appliance comprises a TV set or a computer.

7. A slave household appliance, comprising:
a sub Bluetooth module configured to receive and send information; and
a sub control module configured to communicate with a master household appliance via the sub Bluetooth module so as to receive a control instruction from the master household appliance and control a working state of the slave household appliance based on the received control instruction.

8. The slave household appliance according to claim 7, wherein
the sub control module is configured to send current working state information of the slave household appliance to the sub Bluetooth module, and the sub Bluetooth module is configured to send received working state information to the master household appliance.

9. The slave household appliance according to claim 7, wherein the slave household appliance comprises an air conditioner, a refrigerator, a washing machine, an electric cooker, an electromagnetic oven, or an electric pressure cooker.

10. A household appliance system, comprising:
at least one master household appliance; and
at least one slave household appliance,
wherein the master household appliance comprises:
a main Bluetooth module configured to receive and send information; and
a main control module configured to communicate a control instruction with the at least one slave household appliance via the main Bluetooth module so as to control a working state of the at least one slave household appliance, and
the slave household appliance comprises:
a sub Bluetooth module configured to receive and send information; and
a sub control module configured to communicate with the master household appliance via the sub Bluetooth module so as to receive the control instruction from the master household appliance and control a working state of the slave household appliance based on the received control instruction.

11. The household appliance system according to claim 10, wherein the household appliance system comprises one master household appliance and a plurality of slave household appliances controlled by the master household appliance.

12. A control method for a master household appliance comprising a main Bluetooth module and a main control module, the control method comprising steps of:
sending a control instruction to the main Bluetooth module through the main control module; and
receiving the control instruction from the main control module through the main Bluetooth module and sending the received control instruction to at least one slave household appliance.

13. The control method according to claim 12, wherein
the master household appliance further comprises a main display module connected to the main control module, and the control method further comprises displaying working state information of the master household appliance and/or the slave household appliance through the main display module.

14. The control method according to claim 12, wherein
the master household appliance further comprises a main input module connected to the main control module, and the control method further comprises inputting an operating instruction to the main control module through the main input module.

15. A control method for a slave household appliance comprising a sub Bluetooth module and a sub control module, the control method comprising steps of:
receiving a control instruction from a master household appliance through the sub Bluetooth module and sending the received control instruction to the sub control module; and
controlling a working state of the slave household appliance based on the received control instruction through the sub control module.

16. A control method for a household appliance system comprising a master household appliance and a slave household appliance, the control method comprising steps of:
sending a control instruction to the slave household appliance through the master household appliance;
receiving the control instruction sent by the master household appliance through the slave household appliance; and
controlling a working state of the slave household appliance based on the received control instruction.
